(19) United States
(12) Patent Application Publication
(10) Pub. No.: US 2019/0063654 A1
(43) Pub. Date: Feb. 28, 2019

(54) Connector for a Fluid Line

(71) Applicant: NORMA Germany GmbH, Maintal (DE)

(72) Inventors: Dennis Unger, Rodenbach (DE); René Schindler, Maintal (DE)

(21) Appl. No.: 16/118,701

(22) Filed: Aug. 31, 2018

(30) Foreign Application Priority Data
Aug. 31, 2017 (DE) 102017119979.9

(51) Int. Cl. F16L 37/10

(52) U.S. Cl. CPC F16L 37/101

(57) ABSTRACT

The disclosure relates to a connector for a fluid line which includes a tubular housing. A receiver for a connecting piece is present in the tubular housing. The receiver is surrounded by an integral, continuous rotary ring. The rotary ring is pretensioned for locking the connector into a locked position and is rotatable for unlocking the connector into a released position. At least one guide channel is configured in an outer envelope surface of the tubular housing. This guide channel has an inlet on a first front face of the tubular housing. The rotary ring is received at least partially in the guide channel.

### CROSS-REFERENCE TO RELATED APPLICATION

This application claims the benefit of German Patent Application No. 10 2017 119 979.9, filed Aug. 31, 2017, the entire contents of which are hereby incorporated by reference.

### TECHNICAL FIELD

The disclosure relates to a connector for a fluid line.

### BACKGROUND

In the automotive industry, the supply industry or in ventilation technology it is periodically necessary to connect pipes, hoses, pipe connectors or other fluid lines. Depending on the field of use, such connections have to fulfil requirements, for example with regard to compressive strength, tightness, temperature resistance and/or mechanical stability. These requirements may arise when such connections are used for connecting fuel tanks or in cold water circuits of motor vehicles.

It is known to connect together fluid lines such as hoses, pipes, pipe connectors and/or other elongated hollow bodies in many different ways. Thus, a hose may be connected to a pipe, a pipe may be connected to a connecting piece or, for example, a hose may be connected to a connecting piece via a corresponding connector.

A device for connecting two elongated hollow bodies (hereinafter, tubes) without the use of tools is disclosed, for example, in WO 2009/082 288 A1. In this case, a first connecting piece, a first tube being fastenable thereto, is configured as an annular housing. This first connecting part has the geometry of a female connector. A second connecting part or a second tube is configured as a male connector and has the geometry of a male connector. The second connecting part is insertable along a central axis into the first connecting part and by means of the device is lockable and unlockable without the use of tools. To this end, according to WO 2009/082 288 A1 a rotary ring, a guide ring and an O-ring are provided, said rings being arranged axially adjacent to one another inside the housing. The O-ring in this case is removed furthest from the second connecting part in the axial direction, whilst the rotary ring is arranged next to the second connecting part in the axial direction. The guide ring is arranged between the O-ring and the rotary ring in the axial direction, wherein in a radial direction the O-ring is arranged between the first and the second connecting part which protrudes into the first connecting part.

The design of such a connector sometimes calls for at least three parts which have to be movable relative to one another. Additionally, the number of different parts and the requirement to provide a rotary ring and a guide ring results in a complex construction of the connector.

### SUMMARY

It is the object of the disclosure, in an embodiment, to provide a reliable lockable connector which has a reduced number of individual parts and requires a reduced effort in the assembly thereof. The connector is intended to be able to be produced with low material expenditure and in a cost-effective and rapid manner. Additionally, the connector is intended to be of a space-saving and weight-saving design.

In a connector for a fluid line, comprising a tubular housing with a receiver for a connecting piece and an integral, continuous rotary ring which surrounds the receiver, wherein the rotary ring is pretensioned for locking the connector into a locked position and is rotatable for unlocking the connector into a released position, according to an embodiment it is provided that at least one guide channel is configured in the outer envelope surface of the housing, said guide channel having an inlet on a first front face of the housing, wherein the rotary ring is at least partially received in the guide channel. In an embodiment, the housing is configured integrally. This results in a greater stability of the connector.

An embodiment provides that the guide channel extends from the inlet with an arcuate portion in the direction of a second front face of the housing. In a further embodiment, it is provided that the arcuate portion transitions into a portion parallel with the front face. By such an embodiment, the rotary ring is able to be easily mounted onto the housing. The rotary ring is placed onto the inlet of the guide channel and by means of the arcuate portion is pushed axially onto the housing in the direction of the second front face of the housing. The portion parallel with the front produces a guide for the rotary ring, the rotary ring being rotatable in the peripheral direction about the housing without the rotary ring being displaced in the axial direction. The provision of the arcuate portion in combination with the portion of the guide channel parallel with the front face results in a dual function. The arcuate portion serves for the simple mounting of the rotary ring onto the housing, whilst a reliable guidance of the rotary ring is provided by the portion of the guide channel parallel with the front face for locking and unlocking. In addition, the embodiment provides that the rotary ring is guided through the guide channel on the housing in the peripheral direction. Thus, it is identified that the guide channel forms a guide slot.

Moreover, according to an embodiment it is provided that the guide channel extends along a peripheral portion of the housing. By the extension of the guide channel in some areas it is achieved that the channel is delimited in a peripheral direction. In this manner, a limit which is located in the peripheral direction is provided for the rotary ring.

In an embodiment, it is provided that the rotary ring is able to be pushed onto the housing along the guide channel and is able to be brought into the locked position. Thus, a simple mounting of the rotary ring on the housing may be achieved. In particular, therefore, the rotary ring may be mounted automatically onto the housing. By the transfer into a locked position, the rotary ring is in a defined position in which it is pretensioned. The mounting of the rotary ring onto the housing, therefore, ends in the locked position in which a pretensioning is applied counter to a released position. In an embodiment, the rotary ring is accordingly no longer dismantlable from the locked position via the guide channel, in particular not via the arcuate portion of the guide channel.

According to an embodiment, it is provided that the axial movement of the rotary ring is defined by the guide channel. In this manner, a simple and precise operation of the rotary ring is provided counter to the pretensioning thereof.

In an embodiment, it is provided that the rotary ring comprises a grip part. By means of a grip part, the rotary ring is able to be grasped easily by a user. This may be beneficial, in particular, when the rotary ring and/or the connector is not visible and the operation of the connector by the user is carried out blind. This may be the case, for example, in an engine compartment of a motor vehicle. Additionally, by a correspondingly designed grip part, an increased torque and/or an increased retaining force is able to be transmitted by the user to the grip. This may be beneficial, in particular, when a particularly secure locking of the connector is required. Preferably, the connector in this case is provided with increased pretensioning. If the connector is installed in an engine compartment of a motor vehicle, the grip part may contribute to the production of an improved force transmission by the user to the grip if, for example, fluids located on the grip impair the force transmission. Therefore, a further optional structural measure provides that the grip part comprises at least two step-shaped grip portions extending in the peripheral direction.

According to an embodiment, it is provided that the rotary ring comprises at least one locking element. In an example, the rotary ring comprises more than six locking elements, particularly eight to ten locking elements in different examples. According to an embodiment, it is provided that the locking element is inserted in the guide channel. As the locking element is inserted in the guide channel the rotary ring is guided in the guide channel whilst the locking element is able to be used for locking the connector. The locking element represents the sole guidance of the rotary ring in the housing. In this manner, the guide channel only has to be designed for receiving the locking element, whilst the rotary ring bears with an annular part against the outer face of the outer envelope surface.

According to an embodiment, it is provided that the locking element has a spring geometry. An embodiment provides that the spring geometry is designed as a resilient connection of the locking element to the rotary ring. The housing may have a sloping surface for unlocking the connector. Preferably, it is provided that for transferring the connector into the released position the rotary ring is rotated in the peripheral direction and at the same time a connection between the ring and the locking element counter to the pretensioning thereof is guided along the sloping surface. The sloping surface is arranged in a base of the guide channel or at an end of the guide channel opposing the inlet. By the provision of a spring geometry, the rotary ring is transferred from a released position into a locked position.

In an embodiment, the housing comprises a recess which is configured as an aperture through a housing wall and which penetrates a base of the guide channel. Preferably, it is provided that the locking element is in engagement with the recess in the locked position. According to an embodiment, it is provided that the locking element penetrates the recess in the locked position. A recess configured in this manner is suitable, so that the connector locks a connecting piece, hose part or the like inserted into the connector. In particular, it is suitable if the locking element is in engagement with the aperture designed as a recess, since the rotary ring is thus retained in a locked position. An inadvertent unlocking of the connector, therefore, may not take place.

In an embodiment, it is provided that the guide channel extends in the peripheral direction beyond the recess. This results in that the rotary ring is rotatable beyond the recess in the guide channel. A locking element is guided on an edge of the recess opposing the inlet via an oblique portion. Thus, a spring-loaded locking element may be brought out of engagement with the recess by a rotation of the rotary ring in the peripheral direction away from the inlet, whilst a guidance of the rotary ring in the guide channel is further ensured. Correspondingly, according to an embodiment it is provided that the base of the guide channel has a sloping surface at the end of the guide channel opposing the inlet. The sloping surface directly adjoins the recess. Thus, according to an embodiment it is provided that the recess is arranged in the guide channel between the inlet and the sloping surface.

An embodiment provides that for transferring the connector into the released position the rotary ring is rotated in the peripheral direction and at the same time a spring geometry counter to the pretensioning thereof corresponds to the base of the guide channel. In an embodiment it is provided that the spring geometry corresponds to the sloping surface. In this manner, the above-described effects, namely the transfer into a released position and the unlocking of the connector, may also be achieved whilst a guidance of the rotary ring by the locking element in the guide channel remains ensured.

According to an embodiment, it is provided that the rotary ring has a pressure element which presses a hose inserted into the connector with the connector in the locked position. By a connector designed in such a manner it is ensured that a particularly sealed connection is guaranteed between the connector and a component inserted into the connector, for example a hose or a connecting piece.

According to an embodiment, it is provided that the housing has a sealing seat for a sealing ring in the inner envelope surface. An embodiment provides that the sealing seat is formed by a collar or shoulder which protrudes radially inwardly from the inner envelope surface. The sealing seat may preferably receive a sealing element, whereby a seal is able to be produced between the connector and a connecting piece which is able to be inserted into the connector. In this manner, a secure connection is achieved by the connector.

Moreover, in an embodiment it may be provided that the rotary ring has a shaped portion which protrudes into a radial depression in the outer envelope surface of the housing. By such corresponding elements the user is able to identify easily from outside whether the rotary ring is in the locked position or in the released position.

In an embodiment, the rotary ring and/or the housing is produced by injection-moulding. This may be beneficial, in particular, with regard to the production costs since injection-moulded parts are able to be produced in large quantities in a rapid and cost-effective manner.

### BRIEF DESCRIPTION OF THE DRAWINGS

Further features, details and advantages of the disclosure are disclosed from the wording of the claims and from the following description of exemplary embodiments with reference to the drawings, in which:

FIG. 1 shows a perspective, schematic view of the connector with the rotary ring positioned thereon;

FIG. 2 shows a perspective, schematic view of the rotary ring; and

FIG. 3 shows a view of the housing cut away in the receiving region.

### DETAILED DESCRIPTION

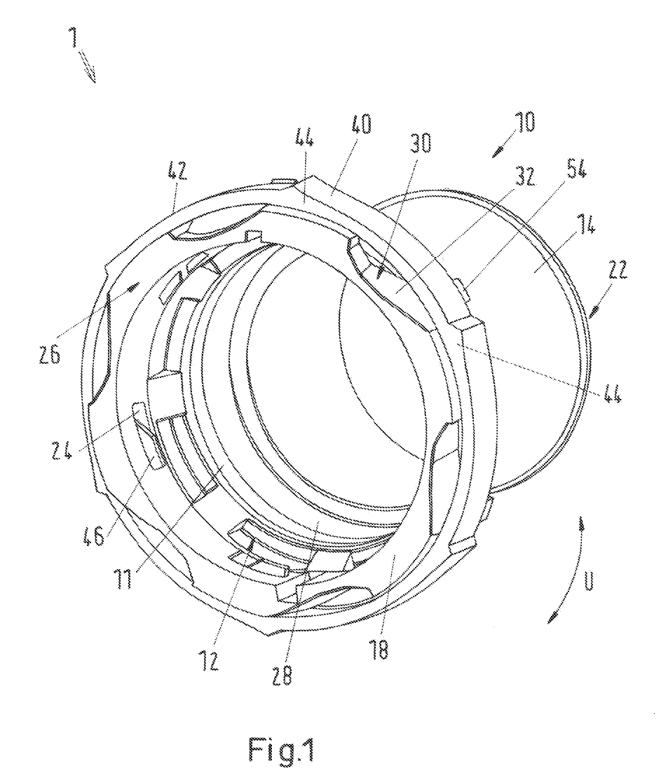

FIG. 1 shows a perspective schematic view of the connector 1 with the rotary ring 40 positioned thereon. The connector 1 has a housing 10 and a rotary ring 40. The housing is configured to be substantially cylindrical and has a housing wall 26 with an inner envelope surface 28 and an outer envelope surface 14.

Moreover, the housing 10 comprises a receiver 12 on a first front face 18. The receiver 12 serves for receiving a hose or a connecting piece which is insertable into an internal region of the housing 10. The connector 1 connects this hose or connecting piece to a further element which, for example, may be a hose or connecting piece and is arranged at the other end, for example on the second front face 22 of the housing 10.

As an alternative to or in combination with the embodiment shown in FIG. 1, a connecting piece may also be connected, in particular permanently, to the second front face 22. Additionally, it may be provided that on the second front face 22 the housing 10 has a male connector for connecting to further guide elements. Alternatively it may be provided that on the second front face 22 the housing 10 has a welding geometry by which a pipe is connectable to the connector, in particular is permanently connectable thereto. In a further embodiment it is provided that on the second front face 22 the housing 10 has a seat for a clip, whereby on the second front face a hose is connectable to the housing 10 and/or the connector 1.

According to FIG. 1, a sealing seat 11 for a sealing element, for example a sealing ring, O-ring or the like, is arranged in the inner envelope surface 28 and, in particular, in the region of the receiver 12, said sealing seat being configured as a radially inwardly protruding shoulder. The inner envelope surface may also contain further radially inwardly protruding shoulders which may optionally serve as a stop for the hoses or connecting pieces inserted into the receiver.

An inlet 32 of a guide channel is arranged on the first front face 18 of the housing 10. Preferably, the housing 10 comprises four to eight guide channels 30, particularly preferably the housing 10 comprises six guide channels 30. The guide channel 30 extends on an outer face of the housing in the housing wall 26 initially with an arcuate portion 34 in the direction of the second front face 22 of the housing 10. A portion 36 parallel to the front face adjoins the arcuate portion 34. The guide channel 30 extends in the housing wall in a peripheral direction U along a partial peripheral portion. The guide channel 30 is located in the region of the receiver 12 of the housing 10.

At least one recess 24 is also arranged in the region of the receiver 12. Preferably, in the region of the receiver 12 four to eight, particularly preferably six, recesses 24 are evenly distributed in the peripheral direction U. The recess 24 penetrates the housing wall 26 and in a base of the guide channel 30, in particular, leads into the portion 36 parallel to the front face.

Moreover, the connector has a rotary ring 40 which is arranged on the outer envelope surface 14 of the housing 10. The rotary ring 40 is preferably arranged in the region of the receiver 12 and is partially inserted in the guide channel 30. The rotary ring 40 has a grip part 42 which is formed by step-shaped portions 44. Preferably, the grip part 42 has four to six step-shaped portions 44, particularly preferably the grip part 42 has six step-shaped portions 44. The inner face of the grip part 42 corresponds to the outer envelope surface 14 in the region of the receiver 12 of the housing 10.

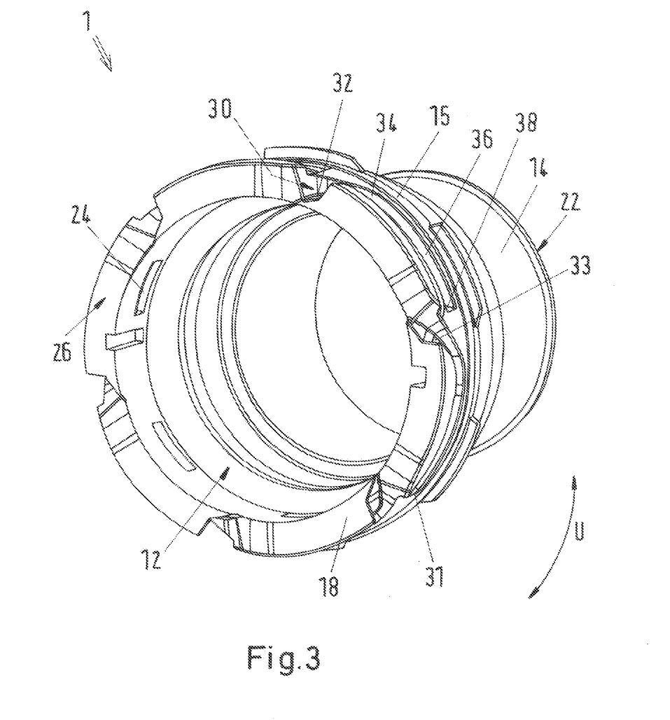

The step-shaped portions 44 extend in the peripheral direction U so that the external diameter is increased from a normal diameter over a short peripheral portion of the grip part 42 and then is reduced again to a normal diameter over a longer peripheral portion. In this case, the internal diameter of the grip part 42 remains the same and corresponds substantially to the external diameter of the outer envelope surface 14 of the housing 10 in the region of the receiver 12. The grip part 42 of the rotary ring also has a shaped portion 54 which is in engagement with the housing 10, in particular with a radial depression 15 of the housing 10 (see FIG. 3 relative thereto).

The rotary ring 40 also has at least one locking element 46 which is arranged on the inner face of the rotary ring 40. Preferably, the rotary ring 40 has four to eight locking elements 46, particularly preferably the rotary ring 40 has six locking elements 46. The locking element 46 is inserted in the guide channel. In a locked position shown in FIG. 1, the locking element 46 is in engagement with the recess 24 of the housing 10.

The rotary ring 40 is thus guided in the guide channel 30 of the housing 10 in the peripheral direction U, wherein the locking elements 46 are inserted in the guide channel 30. The rotary ring 40 may be pushed onto the housing 10 through the inlet 32 of the guide channel 30. This may also take place by means of automated processes, since only a combined translation-rotation movement is required. This is able to be implemented, for example, by manipulators with at least two degrees of freedom.

The rotary ring 40 mounted on the housing 10 is movable (twistable and/or rotatable) in the peripheral direction U and at the same time is inserted in the guide channel 30 and, in particular, in a portion 36 of the guide channel 30 parallel to the front face.

In a locked position the rotary ring 40 is in engagement with the recess 24 of the housing 10 by means of its locking element 46. The rotary ring 40 is rotatable in order to transfer the connector 1 into the released position in the peripheral direction U in the direction of the end 38 of the guide channel 30 opposing the inlet 32. In this case the locking element 46 is brought out of engagement with the recess 24.

The rotation of the rotary ring 40 is able to be carried out easily by a user by means of the grip part 42, which comprises step-shaped portions 44. The shaped portion 54 of the grip part 42 and/or the rotary ring 40 in engagement with the recess 24 in the housing 10 indicates to the user the position (locked position or released position) of the connector 1.

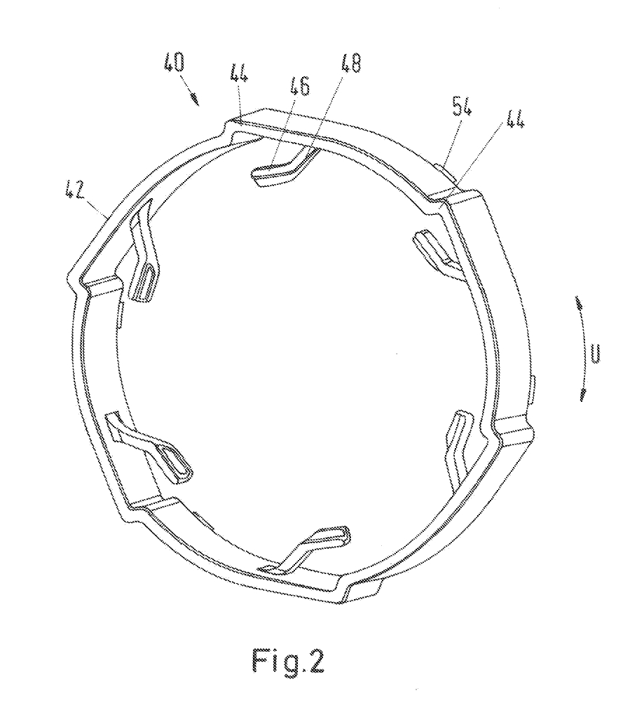

FIG. 2 shows a perspective schematic view of the rotary ring 40. As described above, the rotary ring 40 has a grip part 42. Locking elements 46 are arranged on the grip part 42 on the inner face thereof. These locking elements 46 are connected to the grip part 42 by means of spring geometries 48 which may be configured as projections between the locking element 46 and the grip part 42. Contrary to the above embodiments, the rotary ring as visible in FIG. 2 may also have the step-shaped design on the inner face thereof due to the step-shaped grip portions 44.

FIG. 3 shows a view of the housing 10 cut away in the region of the receiver 12. Here it may be identified that the guide channel 30 transitions from the inlet thereof 32 into the portion 36 parallel to the front face via the curved portion 34. In this case, the end 38 opposing the inlet 32 is located in approximately the same peripheral position as the inlet 32 of the adjacent guide channel 30 in the direction of the guide channel 30. The recess 24 which is configured as an aperture through the housing wall 26 is present in the base 33 of one respective guide channel 30. The recess 24 is located in the portion 36 of the guide channel 30 parallel to the front face, wherein this portion 36 of the guide channel 30 parallel to the front face extends in both directions parallel to the peripheral direction U from the recess 24. Alternatively, it may be provided that the recess 24 with a side located in a peripheral direction U adjoins the end 38 of the guide channel 30 opposing the inlet 32.

A sloping surface 31 is arranged at the end 38 of the guide channel 30 opposing the inlet 32 and/or in the region of the recess 24 on the side of the recess 24 which faces the end 38 of the guide channel 30 opposing the inlet 32. The locking element 46 runs on this sloping surface 31 when the connector is transferred from a locked position into a released position. The sloping surface 31 ensures that the spring geometry 48 retracts or extends and thus brings the locking element 46 into or out of engagement with the recess 24, wherein at the same time the connector 1 is locked or unlocked.

Moreover, in FIG. 3 it is possible to identify the recess 15 by which the shaped portion 54 of the rotary ring 40 is able to be brought into engagement for displaying the locked or unlocked position when the rotary ring 40 is mounted on the housing 10.

The disclosure is not limited to one of the embodiments described above but is able to be modified in many different ways.

It may be seen that a connector for a fluid line has an integral tubular housing 10. A receiver 12 for a connecting piece is present in the housing 10. The receiver 12 is surrounded by an integral, continuous rotary ring 40. The rotary ring 40 is pretensioned for locking the connector 1 in a locked position and rotatable for unlocking the connector into a released position. According to the invention, it is provided that at least one guide channel 30 is configured in the outer envelope surface 14 of the housing 10. This guide channel 30 has an inlet 32 on a first front face 18 of the housing 10. The rotary ring 40 is received at least partially in the guide channel 30.

All of the features and advantages disclosed from the claims, the description and the drawings, including structural details, spatial arrangements and method steps, may be essential to the invention both per se and in all types of combinations. It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. Connector for a fluid line, comprising:
a tubular housing with a receiver for a connecting piece and an integral, continuous rotary ring which surrounds the receiver, wherein the rotary ring is retensioned for locking the connector into a locked position and is rotatable for unlocking the connector into a released position, wherein at least one guide channel is configured in an outer envelope surface of the tubular housing, the guide channel having an inlet on a first front face of the tubular housing, wherein the rotary ring is received at least partially in the guide channel.

2. Connector according to claim 1, wherein the guide channel extends from the inlet with an arcuate portion in the direction of a second front face of the tubular housing.

3. Connector according to claim 1, wherein the rotary ring is guided through the guide channel on the tubular housing in a peripheral direction (U).

4. Connector according to claim 1, wherein the rotary ring is able to be pushed onto the tubular housing along the guide channel and is able to be brought into the locked position.

5. Connector according to claim 1, wherein an axial movement of the rotary ring is defined by the guide channel.

6. Connector according to claim 1, wherein the rotary ring comprises a grip part.

7. Connector according to claim 6, wherein the grip part comprises at least two step-shaped grip portions extending in a peripheral direction (U).

8. Connector according to claim 1, wherein the rotary ring comprises at least one locking element.

9. Connector according to claim 1, wherein the tubular housing comprises a recess which is configured as an aperture through a housing wall and which penetrates a base of the guide channel.

10. Connector according to claim 8, wherein the locking element is in engagement with a recess of the tubular housing in the locked position, the recess being configured as an aperture through a housing wall and penetrating a base of the guide channel.

11. Connector according to claim 10, wherein the guide channel extends in a peripheral direction (U) beyond the recess.

12. Connector according to claim 10, wherein the base of the guide channel has a sloping surface at an end of the guide channel opposing the inlet.

13. Connector according to claim 1, wherein the rotary ring has a pressure element which presses a hose inserted into the connector with the connector in the locked position.

14. Connector according to claim 1, wherein the tubular housing has a sealing seat for a sealing ring in an inner envelope surface.

15. Connector according to claim 1, wherein the rotary ring has a shaped portion which protrudes into a radial depression in the outer envelope surface of the tubular housing.
